(19) United States
(12) Patent Application Publication
(10) Pub. No.: US 2025/0085939 A1
(43) Pub. Date: Mar. 13, 2025

(54) INFORMATION PROCESSING APPARATUS, INFORMATION PROCESSING METHOD, AND NON-TRANSITORY COMPUTER READABLE MEDIUM

(71) Applicant: NEC Corporation, Tokyo (JP)

(72) Inventors: Daiki TANAKA, Tokyo (JP); Shunichi Kinoshita, Tokyo (JP); Yusuke Shimada, Tokyo (JP); Daichi Arai, Tokyo (JP)

(73) Assignee: NEC Corporation, Tokyo (JP)

(21) Appl. No.: 18/756,017

(22) Filed: Jun. 27, 2024

(30) Foreign Application Priority Data
Sep. 12, 2023 (JP) 2023-147958

(51) Int. Cl. G06F 8/41; G06Q 10/08

(52) U.S. Cl. CPC G06F 8/433; G06Q 10/08

(57) ABSTRACT

An information processing apparatus capable of performing an analysis appropriately depending on a resource to be operated by a function in an inspection target program is provided. The information processing apparatus includes: an extraction unit configured to extract function call parts each indicating a part of an inspection target program from which a function is called; a specifying unit configured to specify an operation target resource to be operated by the function; and a narrowing unit configured to narrow down, based on the content of the operation of the function on the operation target resource, analysis target parts on which a process flow analysis is performed from the function call parts. The inspection target program includes variable definition processing for defining a variable indicating the operation target resource. The specifying unit specifies an operation target resource indicated by the variable defined in the variable definition processing.

### INCORPORATION BY REFERENCE

This application is based upon and claims the benefit of priority from Japanese patent application No. 2023-147958, filed on Sep. 12, 2023, the disclosure of which is incorporated herein in its entirety by reference.

### TECHNICAL FIELD

The present disclosure relates to an information processing apparatus, an information processing method, and a program.

### BACKGROUND ART

In recent years, infrastructure and enterprise systems have become complex. Therefore, such infrastructure and the enterprise systems are generally composed by combining devices purchased from various external companies, instead of being composed of devices purchased from a single company. As a countermeasure to reduce the risk associated with a supply chain composed in this way, a technique for detecting a fraudulent function in a program has become increasingly important.

As one example of a fraudulent function in a program, a large number of cases in which a backdoor is found in software (or firmware) or hardware purchased from external manufacturers have been reported. The “backdoor” mentioned herein can be defined, for example, as a function incorporated into a program that includes a plurality of functions that compose software as a part of this program, but is unknown to or unwanted by the user.

A manufacturer that coordinates the construction of infrastructure and enterprise systems needs to inspect whether or not a backdoor is included in the program that composes software purchased from an external manufacturer. For example, to analyze a process flow included in the program by performing a static analysis of the program is known. By performing a process flow analysis that focuses on an operation that requires authorization or an operation that may be dangerous if performed improperly, a backdoor can be detected.

As related art, Patent Literature 1 discloses a vulnerability monitoring apparatus capable of detecting a part where a vulnerable library is not appropriately used. The vulnerability monitoring apparatus disclosed in Patent Literature 1 extracts an external input variable in a program by the use of a function that uses an external input that is defined in advance and an argument passed to a main function in accordance with a predetermined determination rule. Further, this vulnerability monitoring apparatus performs monitoring of the extracted external input variable.

[Patent Literature 1] Japanese Unexamined Patent Application Publication No. 2011-150716

### SUMMARY

When a process flow is analyzed, a called part of a library function that is widely used can be specified as a starting point or an end point of the process flow. However, there are many function call part in a program. Therefore, when the process flow analysis is performed without appropriately narrowing down the function call part to be used as the starting point or the end point, a process flow that does not necessarily need to be analyzed is analyzed. As a result, it is possible that false detections of a fraudulent function such as a backdoor may increase.

Therefore, it is desirable that the target area of the process flow analysis is appropriately set in accordance with the target that will be affected if a fraudulent function is executed. However, in the technique disclosed in Patent Literature 1, this problem is not fully taken into account.

The present disclosure has been made in view of the aforementioned problem, and an object of the present disclosure is to provide an information processing apparatus, an information processing method, and a program capable of performing an analysis appropriately depending on the resource to be operated by a function in an inspection target program.

An information processing apparatus according to a first aspect of the present disclosure includes: an extraction unit configured to extract function call parts each indicating a part of an inspection target program from which a function is called; a specifying unit configured to specify an operation target resource to be operated by the function; and a narrowing unit configured to narrow down, based on the content of the operation of the function on the operation target resource, analysis target parts on which a process flow analysis is performed from the function call parts, in which the inspection target program includes variable definition processing for defining a variable indicating the operation target resource, and the specifying unit specifies the operation target resource indicated by the variable defined in the variable definition processing.

In an information processing method according to a second aspect of the present disclosure, a computer executes: an extracting step of extracting function call parts each indicating a part of an inspection target program from which a function is called; a specifying step of specifying an operation target resource to be operated by the function; and a narrowing step of narrowing down, based on the content of the operation of the function on the operation target resource, analysis target parts on which a process flow analysis is performed from the function call parts, the inspection target program includes variable definition processing for defining a variable indicating the operation target resource, and in the specifying step, the operation target resource indicated by the variable defined in the variable definition processing is specified.

A program according to a third aspect of the present disclosure causes a computer to execute: an extracting step of extracting function call parts each indicating a part of an inspection target program from which a function is called; a specifying step of specifying an operation target resource to be operated by the function; and a narrowing step of narrowing down, based on the content of the operation of the function on the operation target resource, analysis target parts on which a process flow analysis is performed from the function call parts, the inspection target program includes variable definition processing for defining a variable indicating the operation target resource, and in the specifying step, the operation target resource indicated by the variable defined in the variable definition processing is specified.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram showing a functional configuration of an information processing apparatus according to the present disclosure;

FIG. 2 is a flowchart showing a flow of processing performed by the information processing apparatus according to the present disclosure;

FIG. 3 is a diagram showing an example of a backdoor included in a control flow of software according to the present disclosure;

FIG. 4 is a diagram showing a source code for describing a main point of processing performed by the information processing apparatus according to the present disclosure;

FIG. 5 is a diagram showing a source code describing an example of file writing using a file pointer;

FIG. 6 is a diagram showing a source code describing an example of socket writing using the file pointer;

FIG. 7 is a diagram showing a source code describing an example of codes to be specified to narrow down function call parts according to the present disclosure;

FIG. 8 is a block diagram showing a functional configuration of the information processing apparatus according to the present disclosure;

FIG. 9 is a diagram schematically showing a flow of processing of the information processing apparatus according to the present disclosure;

FIG. 10 is a diagram showing one example of a registration function list according to the present disclosure;

FIG. 11 is a diagram showing one example of an extract function list according to the present disclosure;

FIG. 12 is a diagram showing one example of an argument information list according to the present disclosure;

FIG. 13 is a diagram showing one example of a corresponding resource list according to the present disclosure;

FIG. 14 is a flowchart showing a flow of processing of a specifying unit according to the present disclosure;

FIG. 15 is a diagram showing one example of a resource specifying function list according to the present disclosure;

FIG. 16 is a diagram showing one example of a narrowing rule according to the present disclosure;

FIG. 17 is a flowchart showing a flow of processing performed by a narrowing unit according to the present disclosure;

FIG. 18 is a diagram showing one example of an analysis target function list according to the present disclosure;

FIG. 19 is a flowchart showing an overall flow of processing performed by the information processing apparatus according to the present disclosure;

FIG. 20 is a diagram schematically showing processing of the information processing apparatus according to the present disclosure; and

FIG. 21 is a block diagram illustrating a hardware configuration of a computer that implements the information processing apparatus according to the present disclosure.

### EXAMPLE EMBODIMENT

In the following, with reference to the drawings, example embodiments of the present disclosure will be described in detail. Throughout the drawings, the same or corresponding elements are denoted by the same symbols. For the sake of clarification of the description, the overlapping descriptions are partially omitted as appropriate.

### First Example Embodiment

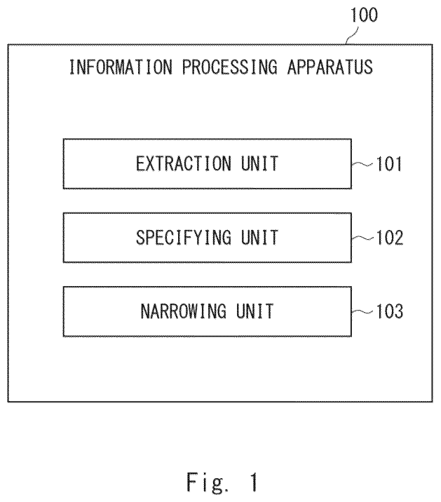

Referring to FIG. 1, an information processing apparatus 100 according to the present disclosure will be described. FIG. 1 is a block diagram showing a functional configuration of the information processing apparatus 100. The information processing apparatus 100 includes an extraction unit 101, a specifying unit 102, and a narrowing unit 103.

The extraction unit 101 extracts function call parts each indicating a part of an inspection target program from which a function is called. The specifying unit 102 specifies an operation target resource which is to be operated by the function. The narrowing unit 103 narrows down, based on the content of the operation of the function on the operation target resource, analysis target parts on which a process flow analysis is performed from the function call parts. Further, the inspection target program includes variable definition processing for defining a variable indicating the operation target resource. The specifying unit 102 specifies the operation target resource indicated by the variable defined in the variable definition processing.

The information processing apparatus 100 includes, as components that are not shown, a processor, a memory, and a storage device. This storage device stores a computer program in which processing according to the present disclosure is implemented. The processor causes the computer program to be loaded to the memory from the storage device to execute this computer program. Accordingly, the processor implements the functions of the extraction unit 101, the specifying unit 102, and the narrowing unit 103.

Each of the extraction unit 101, the specifying unit 102, and the narrowing unit 103 may be implemented by special-purpose hardware. Further, some or all of the components of each apparatus may each be implemented by a general-purpose or special-purpose circuitry, processor, or a combination of them.

They may be configured using a single chip, or a plurality of chips connected through a bus. Some or all of the components of each apparatus may be implemented by a combination of the above-described circuitry, etc. and a program.

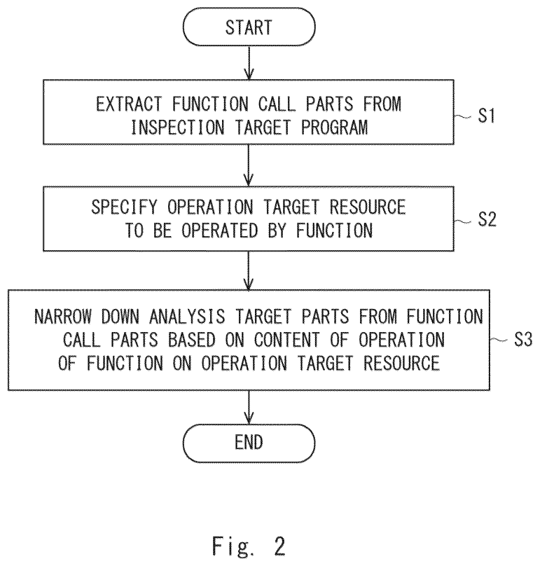

Referring to FIG. 2, a flow of processing performed by the information processing apparatus 100 will be described. FIG. 2 is a flowchart showing a flow of processing performed by the information processing apparatus 100. It is assumed that the inspection target program includes variable definition processing for defining a variable indicating the operation target resource. First, the extraction unit 101 extracts function call parts from the inspection target program (S1). Next, the specifying unit 102 specifies the operation target resource to be operated by the function (S2). The specifying unit 102 specifies the operation target resource indicated by the variable defined in the variable definition processing. Next, the narrowing unit 103 narrows down the analysis target parts from the function call parts based on the content of the operation of the function on the operation target resource (S3).

According to the aforementioned configuration, with the information processing apparatus 100 according to the present disclosure, it is possible to perform an analysis appropriately depending on a resource to be operated by a function in an inspection target program.

### Second Example Embodiment

Next, a second example embodiment will be described. The second example embodiment is a specific example of the aforementioned first example embodiment. In the following, the information processing apparatus 10 according to the present disclosure will be described. The information processing apparatus 10 is an apparatus capable of appropriately narrowing down function call parts to be a starting point or an end point of the process flow analysis in accordance with a resource to be operated by a function in an inspection target program by performing predetermined processing. Accordingly, the information processing apparatus 10 is able to appropriately analyze the inspection target program.

First, as art related to the present disclosure, a technique for inspecting the program will be described. In order to inspect whether or not the program includes a fraudulent function, it is required to analyze codes included in an inspection target program. In the following, an example of the fraudulent function will be described using a backdoor. However, this is merely an example, and the present disclosure can be applied also to a fraudulent function other than the backdoor.

Methods for analyzing a program include a method for performing an analysis using a source code of an inspection target program and a method for performing an analysis using codes included in a binary of the inspection target program. In this example embodiment, an example in which the information processing apparatus 10 performs the process flow analysis of the inspection target program using the source code of the inspection target program will be described.

By performing the process flow analysis, the information processing apparatus 10 is able to detect a code for performing a sensitive operation from the viewpoint of security. The sensitive operation indicates an operation that, if performed improperly, would have a significant impact on a system including the inspection target program or an environment in which this inspection target program is performed. The sensitive operation may be defined in advance by a user. The user is, for example, an inspector who inspects the inspection target program, a client who requests the inspection, or a security staff.

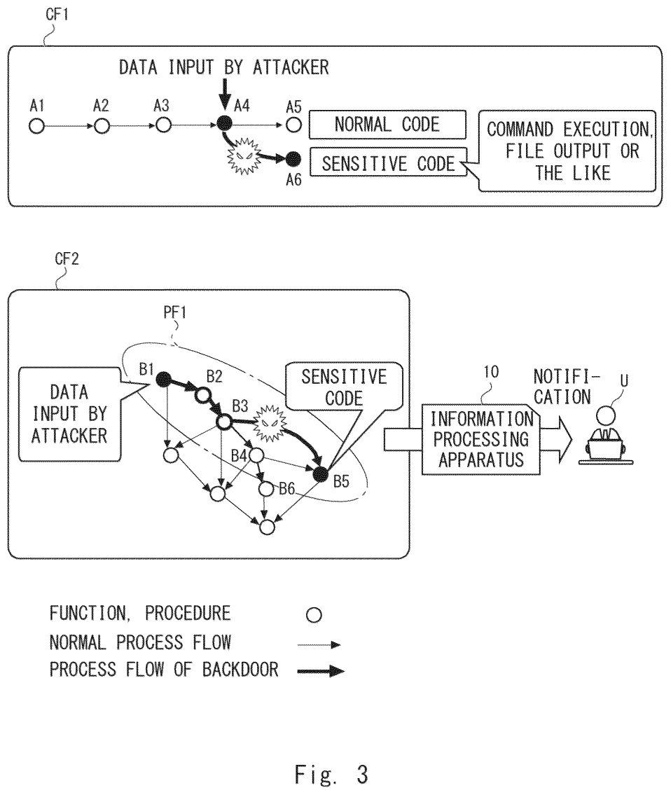

Referring to FIG. 3, an example in which a backdoor is installed in a program will be described. FIG. 3 shows an example of the backdoor included in control flows CF1 and CF2 of software. In FIG. 3, circles indicate functions or procedures. In the following description, a function or a procedure may be referred to as a “node”. Further, in FIG. 3, thin arrows indicate a normal process flow and thick arrows indicate a process flow of the backdoor. In FIG. 3, an inspector U is shown as a user.

In the control flow CFI shown in the upper stage of FIG. 3, nodes A1-A5 are execution paths of a normal code. Normally, when a normal user executes the control flow CF1, processing is executed in a path such as that including the nodes A1, A2, A3, A4, and A5. However, in the example shown in FIG. 3, a backdoor for proceeding the processing from the node A4 to a node A6 is installed. An attacker is able to execute processing of the node A6 without passing through the normal node A5 by performing a predetermined input in the node A4. The attacker is, for example, a person who has installed a backdoor in a program or any person having a relationship with the above person.

The predetermined input performed by the attacker is a special input for implementing a fraudulent function. The predetermined input is, for example, an input for causing a program to execute a sensitive operation without passing through the normal process flow. The predetermined input may include, for example, input information that only the attacker or any person having a relationship with the attacker knows. This input information is, for example, information regarding hidden information that is not described in the specification and the like, information for avoiding an authentication function, or a predetermined command string. These are merely examples, and the input information may include various kinds of input data for implementing the fraudulent function.

The node A6 includes a code for performing the sensitive operation (e.g., command execution, file output or the like) on the system or the like. The attacker installs a backdoor, thereby forming a process flow that is different from the normal process flow to attempt to perform an unauthorized operation. For example, the attacker may install such a backdoor in a program as a hidden function.

The lower stage of FIG. 3 shows an example of the control flow CF2 including branches. In this example, a backdoor for executing fraudulent processing in a path including nodes B1, B2, B3, and B5 is installed in the control flow CF2. For example, an attacker performs a predetermined data input in the node B1, thereby causing processing to be executed in a path including the nodes B1, B2, B3, and B5. The node B5 includes a code for performing a sensitive operation on the system or the like.

Here, the node B5 is a node through which the normal process flow may also pass. It is assumed, for example, that the node B4 is an authentication function for authenticating that the user is a normal user. In the normal process flow, the authentication function is executed in the node B4, and when the authentication has been successful, the processing of the node B5 is executed, whereas when the authentication has failed, processing of a node B6 is executed. According to this procedure, in the normal process flow, the sensitive operation may be executed only when the user has been successful in the authentication and the sensitive operation may not be executed when the user has failed to be authenticated. However, in the control flow CF2, an attacker forms a flow that avoids the authentication function by installing a backdoor that does not pass through the node B4. Accordingly, the attacker is able to execute the sensitive operation while avoiding the authentication function.

The information processing apparatus 10 performs a backdoor inspection for detecting a backdoor by performing the process flow analysis on the process flow defined by a predetermined starting point and a predetermined end point in the inspection target program. For example, in the example of the lower stage in FIG. 3, the predetermined starting point is the node B1 in which data input by the attacker is performed. Further, the predetermined end point is the node B5 including a sensitive code. The sensitive code may include a function that may execute the sensitive operation.

For example, the information processing apparatus 10 performs an analysis on a process flow PF1 having the node B1 as the starting point and the node B5 as the end point. Accordingly, the information processing apparatus 10 inspects whether or not there is a backdoor in the process flow PF1. The information processing apparatus 10 notifies the inspector U of the result of the backdoor inspection based on the results of the analysis. (

### Outline of the Present Disclosure

As described above, the information processing apparatus 10 is able to specify the called part of the library function that is widely used as the starting point and the end point of the process flow in the process flow analysis. However, when the function call parts are specified as the starting point or the end point, the information processing apparatus 10 performs an analysis on the process flow that does not necessarily need to be analyzed as well. As a result, it is possible that false detections of the backdoor may increase. There is another problem that the burden on the inspector U who checks the results of the analysis increases. In order to solve this problem, the information processing apparatus 10 sets the target area of the process flow analysis in view of the target that will be affected if a fraudulent function is executed.

In the present disclosure, in the function call parts in the inspection target program, an operation target resource to be operated by a function is focused on. Specifically, in the inspection target program, it is focused that the function that is used for variable definition processing for defining a variable indicating the operation target resource is different for each resource.

Examples of the operation target resource include a file, a socket, a process, an operation on a user or the like, a buffer which is outside the detection target program, a pipe, a named pipe, or a memory. Other resources may be used as the operation target resource. The called parts of the functions that operate these operation target resources may each be the starting point or the end point of the process flow analysis.

Further, the variable indicating the operation target resource includes, for example, a file descriptor. The file descriptor is identification information that is allocated to identify the file to be operated when the file is operated from the program. The file descriptor is indicated by, for example, an integer value. Further, the access of the socket is performed by access of a special file system called sockfs to a file. Accordingly, the communication of the socket can be read and written (transmitted and received) using the file descriptor.

It is assumed, for example, that the inspection target program includes calling of a function that operates a file and variable definition processing for defining a file descriptor indicating the file to be operated. The information processing apparatus 10 specifies the file indicated by the file descriptor defined in the variable definition processing. Further, the information processing apparatus 10 determines whether or not the function call part is to be the target of the process flow analysis in accordance with the content of the operation of the function on the specified file (e.g., writing to the file).

Accordingly, the information processing apparatus 10 is able to narrow down the analysis target parts in accordance with the resource to be operated by the function in the inspection target program, whereby it is possible to reduce the number of flows to be the target of the process flow analysis.

### Outline of Processing Performed by Information Processing Apparatus 10

Here, a main point of processing performed by the information processing apparatus 10 will be described in detail. In general, a program to be inspected includes a src (source) function, which is a function for acquiring an external input, and a sink function that may perform a sensitive operation on a system including an inspection target program. Arguments of the src function and the sink function each include the variable indicating the operation target resource, such as a file descriptor or a socket descriptor. Further, the inspection target program includes variable definition processing for defining these variables.

In the present disclosure, it is focused that characteristics appear in a function used in the variable definition processing and an argument or the like passed to this function depending on the resource to be operated. When, for example, a function operates a file, an open function is used in the variable definition processing. Further, when a function operates a socket, a socket function is used in the variable definition processing. It is further assumed that, in order to detect unauthorized rewriting of a confidential file, a write function included in the program is extracted. In this case, whether or not the rewriting target is a confidential file or a non-confidential file can be determined by checking the file path passed to the argument of the open function.

The information processing apparatus 10 according to the present disclosure defines in advance to which argument of a function that may become the src function or a function that may become the sink function the variable indicating the operation target resource is given. In the following description, among the arguments of the functions, the argument to which the variable indicating the operation target resource is given may be referred to as a “target argument”. Further, the information processing apparatus 10 defines the function that is used in the inspection target program in advance for each content of the operation performed on the resource. The information processing apparatus 10 narrows down the called parts of the src function or the sink function included in the inspection target program by referring to these information pieces at the time of analysis.

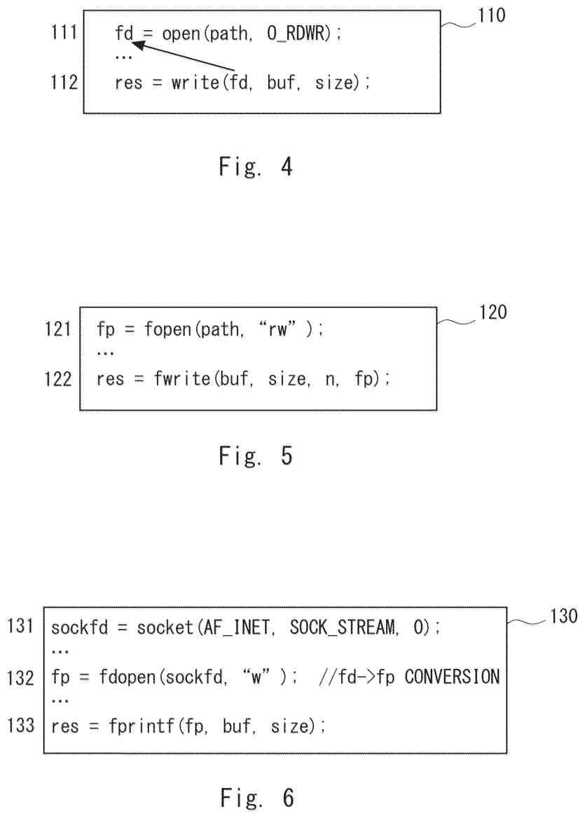

FIG. 4 is a diagram showing a source code 110 for describing a main point of processing performed by the information processing apparatus 10. The source code 110 includes codes 111 and 112. An open function of the code 111 is one example of the src function and a write function of the code 112 is one example of the sink function. As shown in FIG. 4, variable definition processing for defining a variable fd indicating the file descriptor is performed in the code 111. A path, which is a first argument of the open function, indicates a resource to be operated by the open function. Further, in the code 112, the variable fd defined in the code 111 is used as a first argument of the write function. The variable fd corresponds to the aforementioned target argument.

The arrow shown in FIG. 4 shows propagation of information. The arrow shows propagation from the variable fd of the code 112 to the variable fd of the code 111. The information processing apparatus 10 specifies the variable defined in the variable definition processing by tracking the propagation of the variable fd and specifies the operation target resource indicated by this variable. For example, data flow analysis for detecting a fraudulent function such as a backdoor is performed for each process flow having the src function and the sink function as a starting point or an end point. The information processing apparatus 10 is able to appropriately perform the process flow analysis by narrowing down the starting point and the end point of the process flow as appropriate.

For example, in the example shown in FIG. 4, the write function of the code 112 is the starting point of the process flow and the open function of the code 111 is the end point of the process flow. While the starting point of narrowing is a descriptor given to the src function or the sink function in FIG. 4, the starting point may be a descriptor output by the open-system function. That is, propagation of the variable fd in a direction opposite to that of the arrow shown in FIG. 4 may be taken into account.

While the point of narrowing is a descriptor in the above description, the point of narrowing is not limited to the descriptor. For example, a fread function and a fwrite function give a pointer indicating a FILE structure of a file to be operated to the argument. These functions are able to specify the operation target resource by specifying a function used in processing for defining the pointer indicating the FILE structure and a descriptor used in this processing, like in the case where a descriptor is used.

FIG. 5 is a diagram showing a source code 120 for describing an example of file writing using a file pointer. In variable definition processing shown in a code 121, a variable fp is defined. In a code 122, the variable fp is used as a fourth argument of an fwrite function.

FIG. 6 is a diagram showing a source code 130 for describing an example of socket writing using a file pointer. In variable definition processing shown in a code 131, a variable sockfd is defined. In a code 132, the variable sockfd is converted into a variable fp. In a code 133, the variable fp is used as a first argument of an fprintf function.

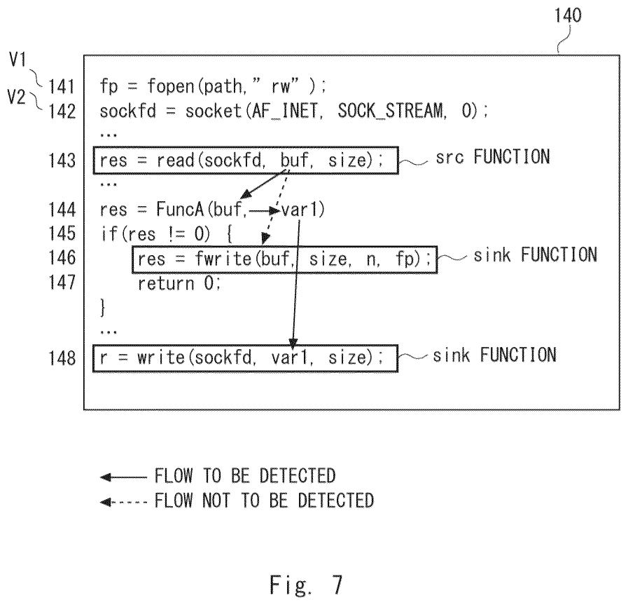

FIG. 7 is a diagram showing a source code 140 for describing an example of codes to be specified in order to narrow down the function call parts. In FIG. 7, solid arrows indicate a flow to be detected and a dashed arrow indicates a flow not to be detected.

In a code 141, a variable fp is defined. Further, in a code 142, a variable sockfd is defined. The processing in the codes 141 and 142 is variable definition processing for defining the variable indicating the operation target resource. In the following, for the sake of explanation, processing indicated by the code 141 may be referred to as variable definition processing V1. Further, processing indicated by the code 142 may be referred to as variable definition processing V2.

In a code 143, an external input is received in buf from the socket by a read function. In a code 144, some processing is performed in FuncA and buf is stored in var1. In a code 146, in error processing of the FuncA function, externally input data is written in the file in the fwrite function. In normal processing shown in s code 148, var1 propagated by the external input is written into the socket by a write function. Accordingly, the content of var1 is externally transmitted.

It is assumed, for example, that the sink function that performs external data transmission has been set as the target of the process flow analysis. The src function includes the read function of the code 143. Further, the sink function includes the fwrite function of the code 146 and the write function of the code 148. Here, the fwrite function of the code 146 merely performs normal writing on the socket read in the code 143 for error processing. Therefore, as shown by the dashed arrow, it is desirable that the fwrite function of the code 146 is excluded from the target of the process flow analysis. On the other hand, the write function of the code 148 treats the socket as a target of writing. Therefore, as shown by the solid arrow, the write function of the code 148 needs to be the target of the process flow analysis.

### Configuration of Information Processing Apparatus 10

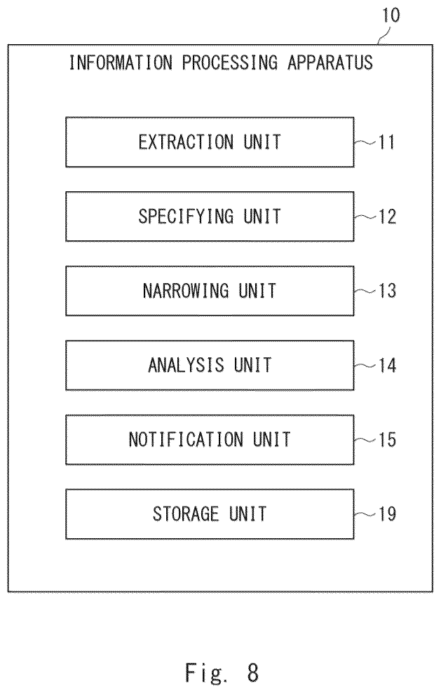

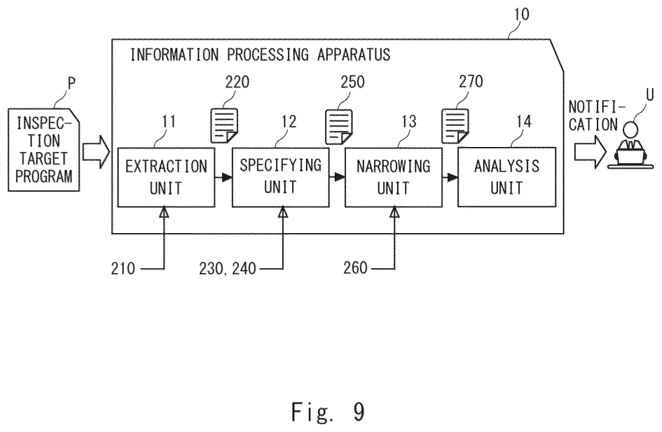

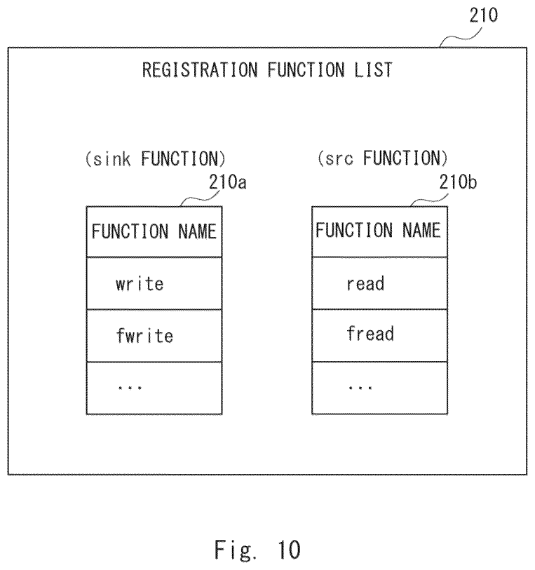

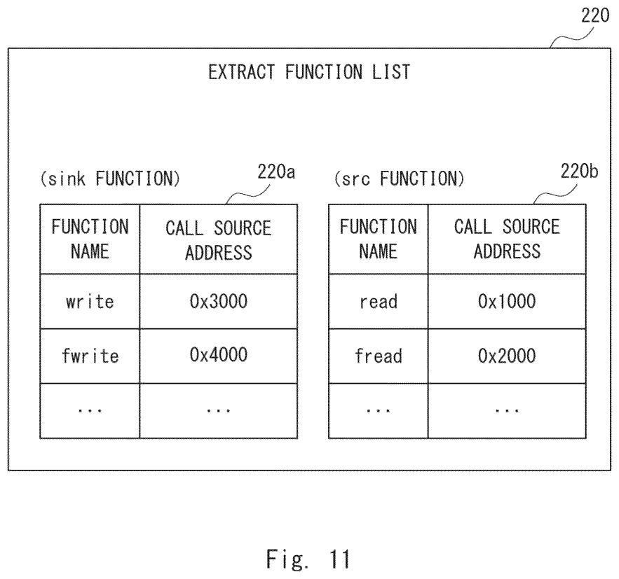

Next, with reference to FIGS. 8 and 9, a configuration of the information processing apparatus 10 according to the present disclosure will be described. FIG. 8 is a block diagram showing a functional configuration of the information processing apparatus 10. FIG. 9 is a diagram schematically showing a process flow of the information processing apparatus 10.

Further, in the following, processing performed by the information processing apparatus 10 using the source code 140 shown in FIG. 7 described above will be specifically described. In the following description, it is assumed that the address of the called part of the fwrite function of the code 146 shown in FIG. 7 is “0x4000”. It is further assumed that the address of the called part of the write function of the code 148 is “0x3000”.

A registration function list 210, a corresponding resource list 240, and a narrowing rule 260 shown in FIG. 9 are stored, for example, in a storage unit 19 of the information processing apparatus 10 in advance. The information processing apparatus 10 acquires these information pieces by referring to the storage unit 19. This is merely an example, and the registration function list 210, the corresponding resource list 240, and the narrowing rule 260 may be stored in an apparatus other than the information processing apparatus 10. The information processing apparatus 10 may acquire these information pieces via a network that is not shown. Note that various kinds of lists described below may be configured in a form other than the form of the list.

The information processing apparatus 10 is one example of the aforementioned information processing apparatus 100. As shown in FIG. 8, the information processing apparatus 10 includes an extraction unit 11, a specifying unit 12, a narrowing unit 13, an analysis unit 14, a notification unit 15, and a storage unit 19.

The extraction unit 11 is one example of the aforementioned extraction unit 101. The extraction unit 11 extracts function call parts each indicating a part of an inspection target program P, which is a program to be inspected, from which a function is called. The extraction unit 11 extracts the function call parts based on the registration function list 210 in which a function that may perform a sensitive operation on the system including the inspection target program P if performed improperly and a function for acquiring an external input are registered in advance.

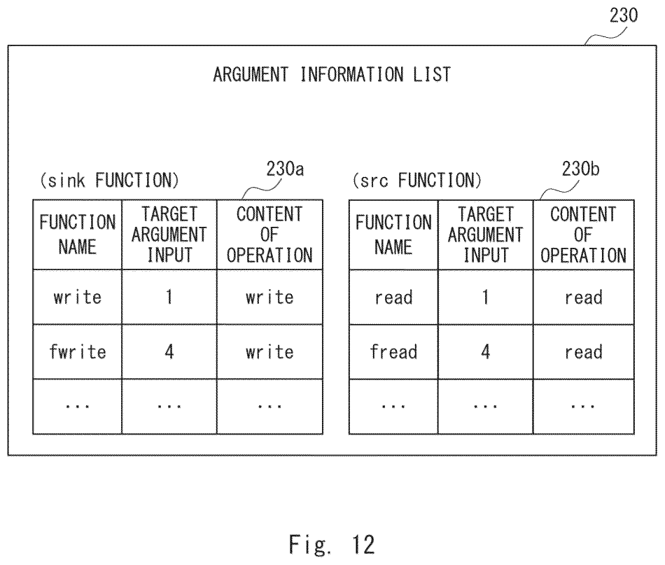

FIG. 10 is a diagram showing one example of the registration function list 210. The registration function list 210 includes a registration function list 210a regarding the sink function and a registration function list 210b regarding the src function. The sink function is the function that may perform the sensitive operation on a system including the inspection target program P. The src function is the function for acquiring the external input. The extraction unit 11 refers to the registration function list 210 and extracts all the parts of the inspection target program P from which these functions are called. The extraction unit 11 stores the results of the extraction in the extract function list 220 and outputs the extract function list 220 to the specifying unit 12.

FIG. 11 is a diagram showing one example of the extract function list 220. The extract function list 220 includes an extract function list 220a regarding the sink function and an extract function list 220b regarding the src function. The extract function list 220 is a list in which the function name and the call source address indicating the called part are associated with each other.

Referring once again to FIGS. 8 and 9, the explanation will be continued. The specifying unit 12 is one example of the aforementioned specifying unit 102. The specifying unit 12 specifies an operation target resource to be operated by a function. As shown in codes 141 and 142 of the source code 140 in FIG. 7, the inspection target program P includes the variable definition processing V1 and V2 for defining variables indicating the operation target resource. The specifying unit 12 specifies the operation target resource indicated by the variables defined in the variable definition processing V1 and V2.

Specifically, the specifying unit 12 specifies the operation target resource based on the argument information list 230 in which the argument number indicating the operation target resource is defined for each of the functions and the corresponding resource list 240 indicating the type of the resource corresponding to the functions used in the variable definition processing V1 and V2.

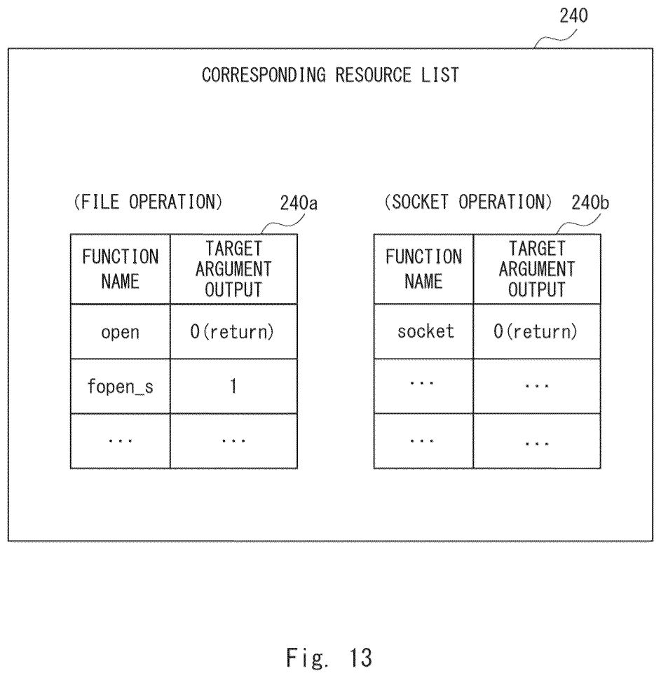

FIG. 12 is a diagram showing one example of the argument information list 230. The argument information list 230 includes an argument information list 230a regarding the sink function and an argument information list 230b regarding the src function. The argument information list 230 is a list in which the function name, the target argument input, and the content of the operation are associated with one another. The target argument input indicates the argument number of a function. The argument information list 230 is defined in advance for each function. The specifying unit 12 extracts the functions included in the argument information list 230 from the functions included in the extract function list 220 output from the extraction unit 11.

Further, the specifying unit 12 specifies, regarding each of the extracted functions, the variable of the argument number described in the argument information list 230 and variable definition processing for defining this variable. As described above, the specifying unit 12 is able to specify variable definition processing by tracking propagation of information related to the variable indicated by the target argument. In the example shown in FIG. 7, the specifying unit 12 specifies the variable definition processing V1 for defining the variable fp. Further, the specifying unit 12 specifies the variable definition processing V2 for defining the variable sockfd.

The specifying unit 12 specifies the types of the resources that correspond to the functions used in the variable definition processing V1 and V2 by referring to the corresponding resource list 240. FIG. 13 is a diagram showing one example of the corresponding resource list 240. The corresponding resource list 240 includes a corresponding resource list 240a regarding the file operation and a corresponding resource list 240b regarding the socket operation. The corresponding resource list 240 is a list in which the function name and the target argument output are associated with each other.

### Processing of Specifying Unit 12

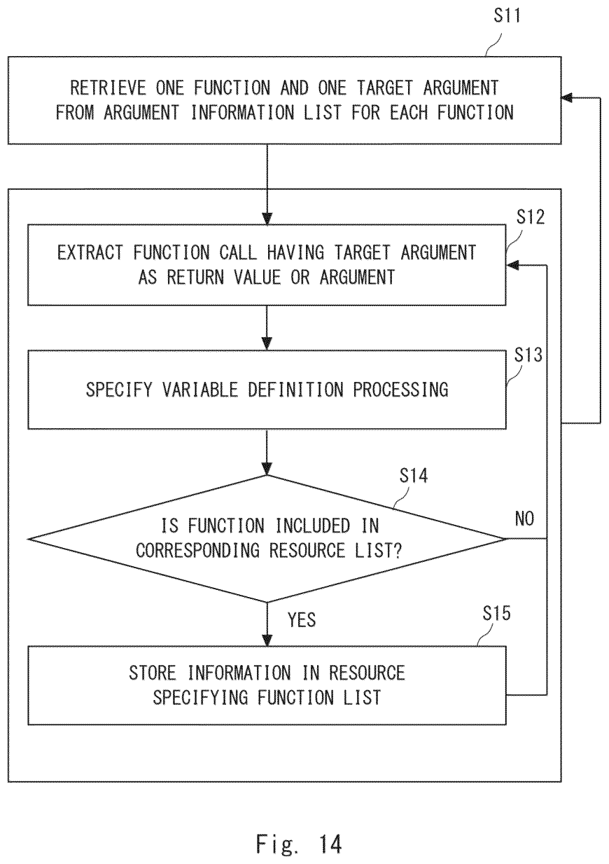

Referring to FIG. 14, a flow of processing of the specifying unit 12 will be described. FIG. 14 is a flowchart showing a flow of processing of the specifying unit 12. First, the specifying unit 12 retrieves one function and one target argument from the argument information list 230 for each function (S11). Next, the specifying unit 12 extracts a function call having a target argument as a return value or an argument (S12). Next, the specifying unit 12 specifies variable definition processing (S13).

Next, the specifying unit 12 determines whether or not each of the retrieved functions is included in the corresponding resource list 240 (S14). When it is determined that the retrieved function is not included in the corresponding resource list 240 (NO in S14), the specifying unit 12 returns the processing to Step S12. When it is determined that the retrieved function is included in the corresponding resource list 240 (YES in S14), the specifying unit 12 stores information on this function in a resource specifying function list 250 (S15). Further, in this case, the specifying unit 12 returns the processing to Step S12 and repeats the following processing. The specifying unit 12 repeats the processing of Steps S12 to S15 until the processing performed regarding the functions and the target arguments included in the argument information list 230 is ended. The specifying unit 12 outputs the resource specifying function list 250 to the narrowing unit 13.

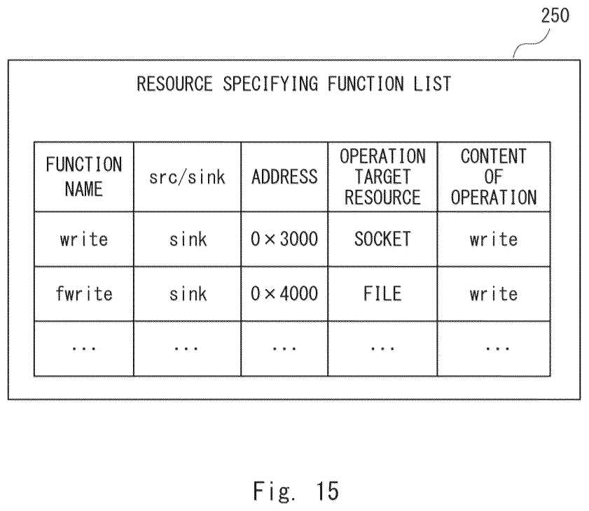

FIG. 15 is a diagram showing one example of the resource specifying function list 250. The resource specifying function list 250 is a list in which the function name, src/sink, the address, the operation target resource, and the content of the operation are associated with one another. The src/sink indicates whether the function indicated by the function name is the src function or the sink function.

Referring again to FIGS. 8 and 9, the explanation will be continued. The narrowing unit 13 is one example of the aforementioned narrowing unit 103. The narrowing unit 13 narrows down, based on the content of the operation of the function on the operation target resource, the analysis target parts on which a process flow analysis is performed from the function call parts. The content of the operation is, for example, read or write. The narrowing unit 13 may narrow down the analysis target parts using a narrowing rule regarding the content of the operation of the function on the operation target resource. Specifically, the narrowing unit 13 narrows down the analysis target parts based on the resource specifying function list 250 output from the specifying unit 12 and a narrowing rule 260 regarding the content of the operation of the function on the operation target resource.

The narrowing rule 260 includes at least one of a rule for making the function call parts the target of the process flow analysis or a rule for excluding the function call parts from the target of the process flow analysis. While the narrowing rule 260 includes a rule for making the function call parts the target of the process flow analysis in the following description, the narrowing rule 260 may include a rule for excluding the function call parts from the target of the process flow analysis. The narrowing rule 260 may be set in advance by an inspector or the like. The narrowing unit 13 narrows down, from the functions included in the resource specifying function list 250, functions that match the narrowing rule 260 as functions to be analyzed.

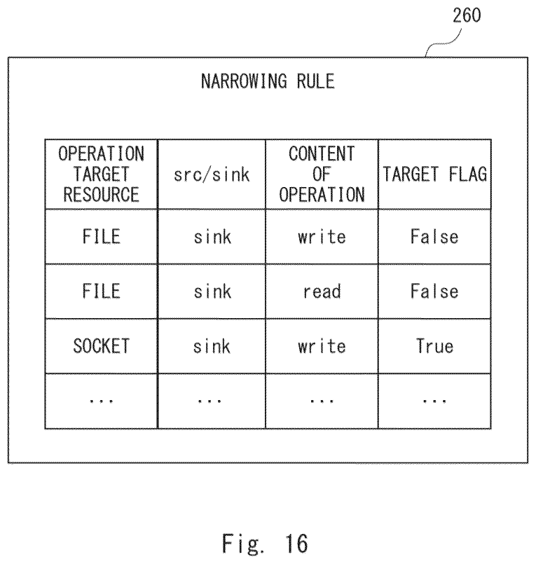

FIG. 16 is a diagram showing one example of the narrowing rule 260. The narrowing rule 260 is a list in which the operation target resource, src/sink, the content of the operation, and the target flag are associated with one another. The target flag is information indicating whether or not the function call part is the target of the process flow analysis. When the target flag is “True”, the narrowing unit 13 determines that the function call part is the target of the process flow analysis. On the other hand, when the target flag is “False”, the narrowing unit 13 determines that the function call part is not the target of the process flow analysis.

The narrowing rule 260 may include resource identification information for identifying the operation target resource as a rule. The resource identification information is, for example, the name of the resource. Specifically, the resource identification information is, for example, a path, a file name, a socket name, and a process name indicating the operation target resource. These are merely examples and the resource identification information may be any kind of information that can specify the operation target resource. The narrowing unit 13 may narrow down the analysis target parts further based on the resource identification information for identifying the operation target resource specified in the specifying unit 12.

Further, the narrowing unit 13 may narrow down the analysis target parts in accordance with the level of confidentiality of an operation target resource indicated by the resource identification information. It is assumed, for example, that a rule for including “/etc/passwd” in the path indicating the resource is set in the narrowing rule 260. In this case, the narrowing unit 13 performs narrowing using one narrowing rule that the path to be operated should include “/etc/passwd”.

### Processing of Narrowing Unit 13

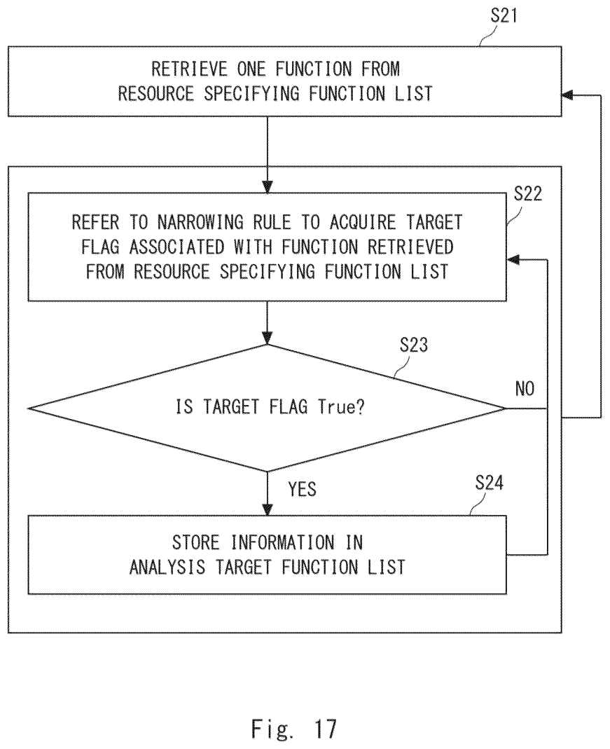

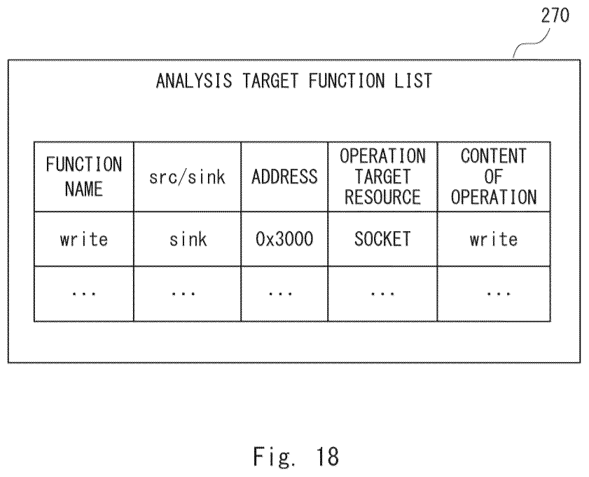

With reference to FIG. 17, a flow of processing of the narrowing unit 13 will be described. FIG. 17 is a flowchart showing a flow of processing performed by the narrowing unit 13. First, the narrowing unit 13 retrieves one function from the resource specifying function list 250 (S21). Next, the narrowing unit 13 refers to the narrowing rule 260 to acquire the target flag associated with the function retrieved from the resource specifying function list 250 (S22). Specifically, the narrowing unit 13 retrieves a target flag of a function in which src/sink, the operation target resource, and the content of the operation (read or write) are the same as those associated with the retrieved function.

Assume, for example, that the narrowing unit 13 has retrieved a write function in the resource specifying function list 250 in Step S21. The src/sink of the write function is “sink”, the operation target resource is “socket”, and the content of the operation is “write”. The narrowing unit 13 refers to the narrowing rule 260 to acquire a target flag of the rule that matches the information pieces of the write function. As shown in FIG. 16, in this example, a rule that matches these information pieces can be found in the third row from the top of the narrowing rule 260. The narrowing unit 13 acquires “True” as the target flag. Likewise, when the narrowing unit 13 has retrieved a fwrite function in the resource specifying function list 250, the narrowing unit 13 acquires “False” as a target flag.

Next, the narrowing unit 13 determines whether or not the target flag is True (S23). When it is determined that the target flag is False (NO in S23), the narrowing unit 13 returns the processing to Step S22. When it is determined that the target flag is True (YES in S23), the narrowing unit 13 stores information on the retrieved function in an analysis target function list 270 (S24).

For example, in the example of the write function and the fwrite function described above, the narrowing unit 13 stores information regarding the write function in which the target flag is “True” in the analysis target function list 270. The narrowing unit 13 stores information including an address “0x3000” of the called part of this write function in the analysis target function list 270. On the other hand, the narrowing unit 13 does not store information regarding the fwrite function in which the target flag is “False” in the analysis target function list 270.

Further, the narrowing unit 13 returns the processing to Step S22, and then the following processing is repeated. The narrowing unit 13 repeats processing of Steps S22 to S24 until processing regarding the functions included in the resource specifying function list 250 is ended. According to this procedure, the narrowing unit 13 is able to output, from the resource specifying function list 250, the analysis target function list 270 as a result of narrowing down the analysis target parts on which the process flow analysis is performed. The narrowing unit 13 outputs the analysis target function list 270 to the analysis unit 14.

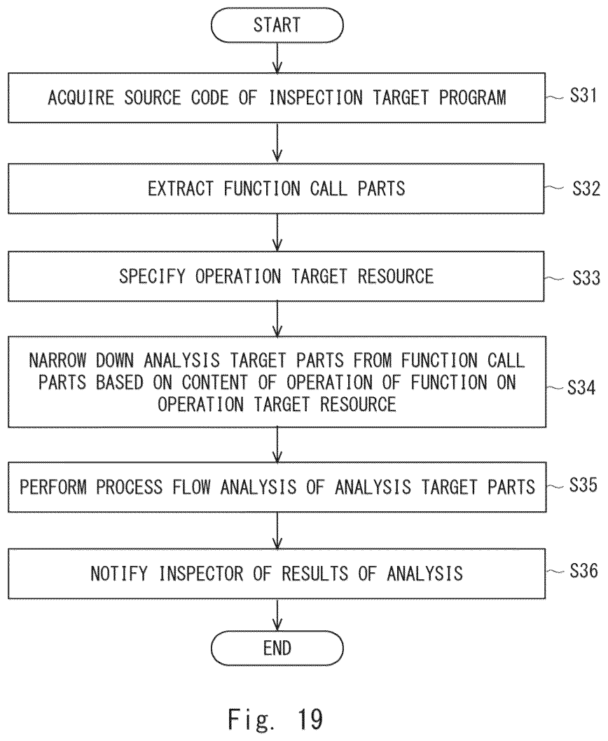

FIG. 18 is a diagram showing one example of the analysis target function list 270. The analysis target function list 270 is a list in which the function name, src/sink, the address, the operation target resource, and the content of the operation are associated with one another. The narrowing unit 13 narrows down the function call parts, whereby the number of function call parts in the analysis target function list 270 is smaller than that in the resource specifying function list 250.

Referring again to FIGS. 8 and 9, the explanation will be continued. The analysis unit 14 performs an analysis on process flows in which the analysis target part narrowed down by the narrowing unit 13 is the starting point or the end point. The analysis unit 14 performs the process flow analysis based on the address stored in the analysis target function list 270. The analysis unit 14 may perform a process flow analysis using any analysis method. Further, the analysis unit 14 outputs the results of the analysis to the notification unit 15.

The notification unit 15 notifies an inspector U (user) of the results of the analysis performed in the analysis unit 14. The notification unit 15 sends the results of the analysis to a PC or the like used by the inspector U via a communication interface for performing communication by a wire that is not shown or wirelessly. The notification unit 15 may send the notification by outputting the results of the inspection as an inspection report. The inspection report indicates, for example, information regarding the backdoor, like “shell program is activated by external input of a hidden password” or “password information output to log file by an external hidden command”. The inspection report may include information regarding the operation target resource. For example, the inspection report may include information such as “operation target resource: confidential document X”.

The storage unit 19, which may be formed of a semiconductor memory or the like, stores various kinds of data and program. At least a part of the storage unit 19 is formed of a non-volatile memory so that the data can be held even after the information processing apparatus 10 is turned off. The storage unit 19 may store, besides the program according to this example embodiment, various kinds of lists described above.

### Processing of Information Processing Apparatus 10

Referring to FIG. 19, an overall flow of processing performed by the information processing apparatus 10 will be described. FIG. 19 is a flowchart showing an overall flow of processing performed by the information processing apparatus 10.

First, the extraction unit 11 acquires a source code of an inspection target program P (S31). The extraction unit 11 extracts function call parts from the acquired source code (S32). The extraction unit 11 may extract the function call parts using the registration function list 210 registered in advance. The extraction unit 11 outputs the extract function list 220 as a result of the extraction.

Next, the specifying unit 12 specifies the operation target resource to be operated by the functions extracted in Step S32 using the argument information list 230 and the corresponding resource list 240 (S33). The specifying unit 12 specifies variable definition processing by tracking propagation of the information related to the variable indicated by the target argument. Further, the specifying unit 12 specifies an operation target resource indicated by the variable defined in the variable definition processing. The specifying unit 12 outputs the resource specifying function list 250 as a result of specifying the operation target resource.

Next, the narrowing unit 13 narrows down the analysis target parts from the function call parts based on the content of the operation of the function on the operation target resource specified in the specifying unit 12 (S34). Specifically, the narrowing unit 13 narrows down the analysis target parts from the function call parts included in the resource specifying function list 250 using the narrowing rule 260. The narrowing unit 13 outputs the analysis target function list 270 as a result of the narrowing.

Next, the analysis unit 14 performs the process flow analysis of the analysis target parts included in the analysis target function list 270 (S35). Lastly, the notification unit 15 notifies the inspector U of the results of the analysis (S36).

As described above, in the information processing apparatus 10 according to the present disclosure, the extraction unit 11 extracts function call parts each indicating the part of the inspection target program from which a function is called. The specifying unit 12 specifies an operation target resource to be operated by the function. The inspection target program includes variable definition processing for defining a variable indicating the operation target resource. The specifying unit 12 specifies the operation target resource indicated by the variable defined in the variable definition processing. The narrowing unit 13 narrows down, based on the content of the operation of the function on the operation target resource, the analysis target parts on which a process flow analysis is performed from the function call parts.

Further, the information processing apparatus 10 is able to narrow down the analysis target parts by prioritizing the operation target resource. For example, the information processing apparatus 10 is able to narrow down the analysis target parts in accordance with the level of confidentiality of the operation target resource.

According to the above-described configuration, the information processing apparatus 10 can reduce the number of functions to be the starting point or the end point of the process flow analysis. Accordingly, it is possible to reduce the time required for the process flow analysis and reduce the number of results sent to an inspector, whereby the burden on the inspector and the cost required for the inspection can be reduced. Accordingly, the information processing apparatus 10 according to the present disclosure is able to perform an analysis appropriately in accordance with the resource to be operated by the function in the inspection target program.

### Modified Examples

In the configuration of the information processing apparatus 10 described above, the narrowing unit 13 narrows down the called parts of the src function or the sink function to be inspected and the analysis unit 14 performs a process flow analysis on the called parts that have been narrowed down. As shown in this modified example, the information processing apparatus 10 may be configured to execute the process flow analysis first to narrow down information to be sent to the inspector U in the narrowing unit 13. In the following description, an information processing apparatus 10a according to this modified example will be described. The content already described in the information processing apparatus 10 described in the second example embodiment will not be described again, and points different from those in the information processing apparatus 10 will be mainly described.

Since a functional configuration of the information processing apparatus 10a is the same as that of the information processing apparatus 10 shown in FIG. 8, the illustration is omitted. Just like the information processing apparatus 10, the information processing apparatus 10a includes an extraction unit 11, a specifying unit 12, a narrowing unit 13, an analysis unit 14, a notification unit 15, and a storage unit 19. In the information processing apparatus 10a, the analysis unit 14 specifies a process flow that may include a fraudulent function. Further, the narrowing unit 13 narrows down the analysis target parts from the function call parts further based on the process flow that may include a fraudulent function specified in the analysis unit 14.

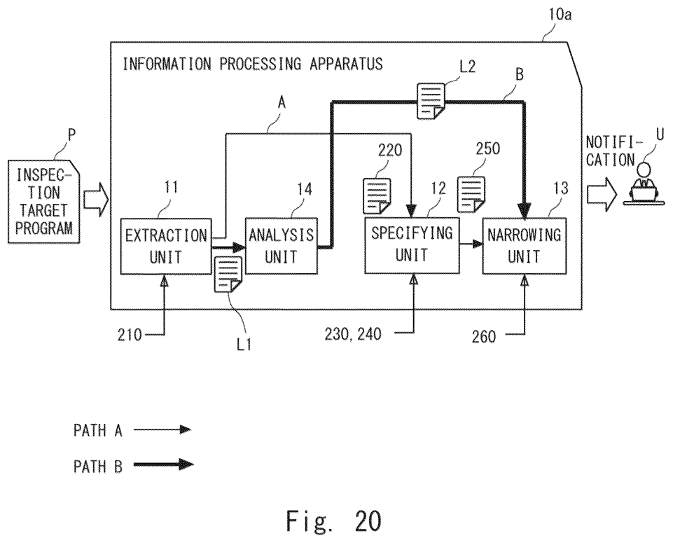

FIG. 20 is a diagram schematically showing processing of the information processing apparatus 10a according to the present disclosure. In the second example embodiment, as described with reference to FIG. 9, the information processing apparatus 10 proceeds the processing in the order of the extraction unit 11, the specifying unit 12, the narrowing unit 13, and the analysis unit 14. In this modified example, the information processing apparatus 10a proceeds the processing in the order as shown in FIG. 20. The information processing apparatus 10a performs processing shown by a path A indicated by thin solid lines and a path B indicated by thick solid lines. In the path A, the information processing apparatus 10a performs processing in the extraction unit 11, the specifying unit 12, and the narrowing unit 13 in this order, like in the flow of processing according to the second example embodiment.

The processing of the path B will be described. In the path B, the information processing apparatus 10a performs processing of the analysis unit 14 after the processing of the extraction unit 11. First, the extraction unit 11 extracts a process flow that may include a fraudulent function such as a backdoor based on the registration function list 210. The extraction unit 11 outputs a function list L1 including the extracted information to the analysis unit 14. The function list L1 includes information on the src function and the sink function included in the process flow that may include the fraudulent function.

The analysis unit 14 performs the process flow analysis based on the function list L1. The analysis unit 14 outputs a process flow list L2 including information on the process flow that may include the fraudulent function such as a backdoor to the narrowing unit 13. The narrowing unit 13 narrows down the analysis target parts based on the resource specifying function list 250 output from the specifying unit 12, and the process flow list L2.

In this modified example, the analysis unit 14 performs an analysis before the narrowing unit 13 narrows down the analysis target parts. Accordingly, according to this modified example, the number of analysis target parts analyzed by the analysis unit 14 is larger than that in the case where the analysis is performed after the narrowing unit 13 narrows down the analysis target parts. However, when the size of the analysis target data of the analysis unit 14 is small, the load of processing in the analysis unit 14 is kept below a predetermined level. Therefore, the information processing apparatus 10a may select the processing in the second example embodiment or the processing in this modified example depending on the size or the like of the analysis target data.

According to the aforementioned configuration, in this modified example, the information processing apparatus 10a is able to achieve effects similar to those in the information processing apparatus 10 according to the second example embodiment. Further, the information processing apparatus 10a is able to perform processing of each process of the path A and the path B in parallel to each other, whereby the processing time can be reduced.

The configurations included in the information processing apparatuses 100, 10, and 10a (hereinafter they will be referred to as “information processing apparatus 100 and so on”) and processing performed by each of them have been described above. The configurations of the information processing apparatus 100 and so on described above are merely examples, and may be changed as appropriate. When, for example, some or all of the components of the information processing apparatus 100 and so on are implemented by a plurality of information processing apparatuses, circuits, or the like, the plurality of information processing apparatuses, the circuits, or the like may be disposed in one place in a centralized manner or arranged in a distributed manner. For example, the information processing apparatuses, the circuits, and the like may be implemented as a form such as a client-server system, a cloud computing system or the like in which they are connected to each other through a communication network. Further, the functions of the information processing apparatus 100 and so on may be provided in the form of Software as a Service (Saas).

### Configuration Example of Hardware

Each functional configuration unit of the information processing apparatus 100 and so on may be implemented by a hardware that implements each functional configuration unit (e.g., a hardwired electronic circuit) or may be implemented by a combination of hardware with software (e.g., a combination of an electronic circuit with a program controlling the same). Hereinafter, a case in which each functional configuration unit of the information processing apparatus 100 and so on is implemented by a combination of hardware with software will be further described.

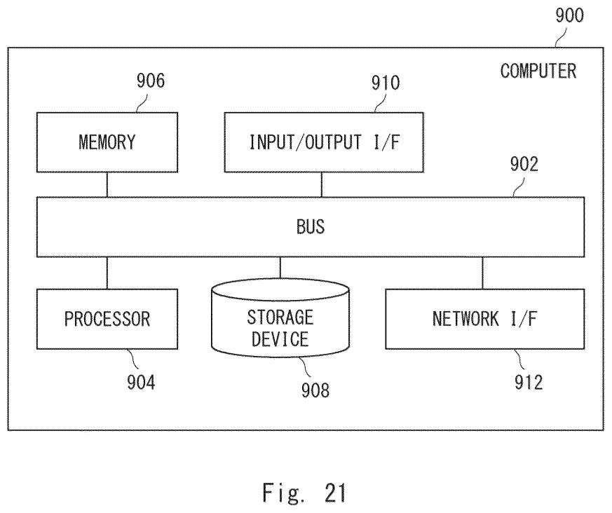

FIG. 21 is a block diagram illustrating a hardware configuration of a computer 900 that implements the information processing apparatus 100 and the like. The computer 900 may be a special-purpose computer designed to implement the information processing apparatus 100 and so on, or may be a general-purpose computer. The computer 900 may be a portable computer such as a smartphone or a tablet terminal.

For example, a predetermined application is installed in the computer 900, whereby each function of the information processing apparatus 100 and so on is implemented in the computer 900. This application is formed of a program for implementing the functional configuration unit of the information processing apparatus 100 and so on.

The computer 900 includes a bus 902, a processor 904, a memory 906, a storage device 908, an input/output interface 910, and a network interface 912. The bus 902 is a data transmission path for enabling the processor 904, the memory 906, the storage device 908, the input/output interface 910, and the network interface 912 to transmit and receive data among them. The method for connecting the processor 904 and the like to one another is not limited to the bus connection.

The processor 904 is any type of processor such as a Central Processing Unit (CPU), a Graphics Processing Unit (GPU), a Field-Programmable Gate Array (FPGA), or a quantum processor (quantum computer control chip). The memory 906 is a main memory unit that is implemented using a Random Access Memory (RAM) or the like. The storage device 908 is an auxiliary storage device that is implemented with a hard disk, a Solid State Drive (SSD), a memory card, or a Read Only Memory (ROM).

The input/output interface 910 is an interface for connecting the computer 900 to an input/output device. An input device such as a keyboard and an output device such as a display device are connected, for example, to the input/output interface 910. The network interface 912 is an interface for connecting the computer 900 to the network. This network may either be a Local Area Network (LAN) or a Wide Area Network (WAN).

The storage device 908 stores a program for implementing each functional configuration unit of the information processing apparatus 100 and so on (a program for implementing the aforementioned application). The processor 904 loads this program into the memory 906 to execute the loaded program, thereby implementing each functional configuration unit of the information processing apparatus 100 and so on.

Each of the processors executes one or more programs including instructions for causing a computer to perform the algorithm described with reference to the drawings. The program includes instructions (or software codes) that, when loaded into a computer, cause the computer to perform one or more of the functions described in the example embodiments. The program may be stored in various types of non-transitory computer readable media or tangible storage media. By way of example, and not a limitation, non-transitory computer readable media or tangible storage media can include a RAM, a ROM, a flash memory, an SSD or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on various types of transitory computer readable media or communication media. By way of example, and not a limitation, transitory computer readable media or communication media can include electrical, optical, acoustical, or other forms of propagated signals.

While the present disclosure has been described with reference to the example embodiments, the present disclosure is not limited to the above-described example embodiments. Various changes that may be understood by one skilled in the art may be made to the configurations and the details of the present disclosure within the scope of the present disclosure. Each of the example embodiments can be combined with another example embodiment as appropriate.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an illustrative example embodiment are necessarily essential, and some features or steps may be omitted. The order of the steps described in any of the figures may be changed as appropriate.

Note that the present disclosure is not limited to the aforementioned example embodiments and may be changed as appropriate without departing from the spirit of the present disclosure.

The information processing apparatus, the information processing method, and the program according to the present disclosure enable an analysis to be performed appropriately depending on a resource to be operated by a function in an inspection target program.

For example, the whole or part of the example embodiments disclosed above can be described as, but not limited to, the following supplementary notes.

### Supplementary Note 1

An information processing apparatus comprising:
an extraction unit configured to extract function call parts each indicating a part of an inspection target program from which a function is called;
a specifying unit configured to specify an operation target resource to be operated by the function; and
a narrowing unit configured to narrow down, based on the content of the operation of the function on the operation target resource, analysis target parts on which a process flow analysis is performed from the function call parts, wherein
the inspection target program includes variable definition processing for defining a variable indicating the operation target resource, and
the specifying unit specifies the operation target resource indicated by the variable defined in the variable definition processing.

### Supplementary Note 2

The information processing apparatus according to Supplementary Note 1, wherein the extraction unit extracts the function call parts based on a registration function list in which a function that may perform a sensitive operation on a system including the inspection target program if performed improperly and a function for acquiring an external input are registered in advance.

### Supplementary Note 3

The information processing apparatus according to Supplementary Note 1or 2, wherein the specifying unit specifies the operation target resource based on an argument information list in which an argument number indicating the operation target resource is defined for each of the functions and a corresponding resource list indicating the type of the resource that corresponds to the function used in the variable definition processing.

### Supplementary Note 4

The information processing apparatus according to any one of

Supplementary Notes 1 to 3, wherein the narrowing unit narrows down the analysis target parts using a narrowing rule regarding the content of the operation of the function on the operation target resource.

### Supplementary Note 5

The information processing apparatus according to Supplementary Note 4, wherein the narrowing rule includes at least one of a rule for making the function call parts the target of the process flow analysis or a rule for excluding the function call parts from the target of the process flow analysis.

### Supplementary Note 6

The information processing apparatus according to any one of Supplementary Notes 1 to 5, wherein the narrowing unit narrows down the analysis target parts further based on resource identification information for identifying the operation target resource.

### Supplementary Note 7

The information processing apparatus according to Supplementary Note 6, wherein the narrowing unit narrows down the analysis target parts in accordance with a level of confidentiality of the operation target resource indicated by the resource identification information.

### Supplementary Note 8

The information processing apparatus according to any one of Supplementary Notes 1 to 7, further comprising an analysis unit configured to perform an analysis on a process flow having the analysis target part narrowed down by the narrowing unit as a starting point or an end point.

### Supplementary Note 9

The information processing apparatus according to any one of Supplementary Notes 1 to 7, further comprising an analysis unit configured to perform an analysis on a process flow having the function call part extracted in the extraction unit as a starting point or an end point, wherein
the analysis unit specifies a process flow that may include a fraudulent function, and
the narrowing unit narrows down the analysis target parts from the function call parts further based on the process flow that may include the fraudulent function.

### Supplementary Note 10

The information processing apparatus according to Supplementary Note 8or 9, further comprising a notification unit configured to notify a user of a result of the analysis performed in the analysis unit.

### Supplementary Note 11

An information processing method, wherein a computer executes:
an extracting step of extracting function call parts each indicating a part of an inspection target program from which a function is called;
a specifying step of specifying an operation target resource to be operated by the function; and
a narrowing step of narrowing down, based on the content of the operation of the function on the operation target resource, analysis target parts on which a process flow analysis is performed from the function call parts, wherein
the inspection target program includes variable definition processing for defining a variable indicating the operation target resource, and
in the specifying step, the operation target resource indicated by the variable defined in the variable definition processing is specified.

### Supplementary Note 12

A program causing a computer to execute:
an extracting step of extracting function call parts each indicating a part of an inspection target program from which a function is called;
a specifying step of specifying an operation target resource to be operated by the function; and
a narrowing step of narrowing down, based on the content of the operation of the function on the operation target resource, analysis target parts on which a process flow analysis is performed from the function call parts, wherein
the inspection target program includes variable definition processing for defining a variable indicating the operation target resource, and
in the specifying step, the operation target resource indicated by the variable defined in the variable definition processing is specified.

Note that some or all of the elements (e.g., the configurations and the functions) according to Supplementary Notes 2 to 10 that depend from Supplementary Note 1 may depend from Supplementary Notes 11 and 12 as well according to a dependency relationship similar to that in Supplementary Notes 2 to 10. Some or all of the elements according to any Supplementary Note may be applied to various kinds of hardware, software, recording means for recording software, system, and method.

What is claimed is:

1. An information processing apparatus comprising:
at least one memory storing instructions, and
at least one processor configured to execute the instructions to:
extract function call parts each indicating a part of an inspection target program from which a function is called;
specify an operation target resource to be operated by the function; and
narrow down, based on the content of the operation of the function on the operation target resource, analysis target parts on which a process flow analysis is performed from the function call parts, wherein
the inspection target program includes variable definition processing for defining a variable indicating the operation target resource, and the at least one processor specifies the operation target resource indicated by the variable defined in the variable definition processing.

2. The information processing apparatus according to claim 1, wherein the at least one processor extracts the function call parts based on a registration function list in which a function that may perform a sensitive operation on a system including the inspection target program if performed improperly and a function for acquiring an external input are registered in advance.

3. The information processing apparatus according to claim 1, wherein the at least one processor specifies the operation target resource based on an argument information list in which an argument number indicating the operation target resource is defined for each of the functions and a corresponding resource list indicating the type of the resource that corresponds to the function used in the variable definition processing.

4. The information processing apparatus according to claim 1, wherein the at least one processor narrows down the analysis target parts using a narrowing rule regarding the content of the operation of the function on the operation target resource.

5. The information processing apparatus according to claim 4, wherein the narrowing rule includes at least one of a rule for making the function call parts the target of the process flow analysis or a rule for excluding the function call parts from the target of the process flow analysis.

6. The information processing apparatus according to claim 1, wherein the at least one processor narrows down the analysis target parts further based on resource identification information for identifying the operation target resource.

7. The information processing apparatus according to claim 6, wherein the at least one processor narrows down the analysis target parts in accordance with a level of confidentiality of the operation target resource indicated by the resource identification information.

8. The information processing apparatus according to claim 1, wherein the at least one processor further performs an analysis on a process flow having the analysis target part narrowed down in the narrowing of the analysis target parts as a starting point or an end point.

9. The information processing apparatus according to claim 1, wherein the at least one processor:
further perform an analysis on a process flow having the function call part extracted in the extraction of the function call part as a starting point or an end point;
specify a process flow that may include a fraudulent function; and
narrow down the analysis target parts from the function call parts further based on the process flow that may include the fraudulent function.

10. The information processing apparatus according to claim 8, wherein the at least one processor further notifies the user of a result of the analysis.

11. An information processing method comprising:
extracting function call parts each indicating a part of an inspection target program from which a function is called;
specifying an operation target resource to be operated by the function; and
narrowing down, based on the content of the operation of the function on the operation target resource, analysis target parts on which a process flow analysis is performed from the function call parts, wherein
the inspection target program includes variable definition processing for defining a variable indicating the operation target resource, and
in the specifying of the operation target resource, the operation target resource indicated by the variable defined in the variable definition processing is specified.

12. A non-transitory computer readable medium storing a program for causing a computer to execute:
extracting function call parts each indicating a part of an inspection target program from which a function is called;
specifying an operation target resource to be operated by the function; and
narrowing down, based on the content of the operation of the function on the operation target resource, analysis target parts on which a process flow analysis is performed from the function call parts, wherein
the inspection target program includes variable definition processing for defining a variable indicating the operation target resource, and
in the specifying of the operation target resource, the operation target resource indicated by the variable defined in the variable definition processing is specified.
